(19) United States
(12) Patent Application Publication
(10) Pub. No.: US 2018/0184383 A1
(43) Pub. Date: Jun. 28, 2018

(54) SYSTEMS, METHODS, AND DEVICES FOR DYNAMIC TRANSMISSION POWER CONTROL ON WIRELESS STATIONS FOR MAXIMIZING WIRELESS CHANNEL UTILIZATION

(71) Applicant: QUALCOMM Incorporated, San Diego, CA (US)

(72) Inventors: Rama Chandra Reddy, Hyderabad (IN); Pradeep Kumar DOMA, Hyderabad (IN)

(21) Appl. No.: 15/393,104

(22) Filed: Dec. 28, 2016

(51) Int. Cl. H04W 52/30; H04L 29/06; H04W 72/04

(52) U.S. Cl. CPC H04W 52/30; H04W 88/08; H04W 72/048; H04L 69/22

(57) ABSTRACT

Systems, methods, and devices for dynamic transmission power control are provided. One aspect provides a method of wireless communication that includes, at a wireless device, transmitting, at a first power level, a first message to an access point and receiving one or more packets from the access point and a plurality of stations. The method further includes, based on the one or more packets, identifying first and second sets of stations of the plurality of stations, the sets including a first and second station, respectively. The method further includes, after identifying the first and second sets of stations, receiving an additional packet from the access point, the additional packet identifying the second station. The method further includes, in response to receiving the additional packet, transmitting, at a second power level, a second message to the first station, the second power level being less than the first power level.

### BACKGROUND

### Field

The present application relates generally to wireless communications, and more specifically, to systems, methods, and devices for dynamic transmission power control on wireless stations for maximizing wireless channel utilization.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Wireless communication systems are widely deployed to provide various types of communication content such as voice and data. Typical wireless communication systems may be multiple-access systems capable of supporting communication with multiple users by sharing available system resources (e.g., bandwidth, transmit power). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP2, 3GPP long-term evolution (LTE), LTE Advanced (LTE-A), LTE Unlicensed (LTE-U), LTE Direct (LTE-D), License-Assisted Access (LAA), MuLTEfire, etc. These systems may be accessed by various types of user equipment (stations) adapted to facilitate wireless communications, where multiple stations share the available system resources (e.g., time, frequency, and power).

Wireless networks are often preferred when network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The prevalence of multiple wireless networks may cause interference, reduced throughput (for example, because each wireless network is operating in the same area and/or spectrum), and/or prevent certain devices from communicating. For the volume and complexity of information communicated wirelessly between multiple devices, the required overhead bandwidth continues to increase. Devices may operate in close proximity to one another and operating over different radio access technologies (RATs) and/or different communication protocols. As more devices are designed to have “smart” technology, for example, kitchen appliances, interferences over networks further intensify. Thus, improved systems and methods for communicating when wireless networks are densely populated and/or have interference are desired.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description,” one will understand how the features of this invention provide advantages that include improved communications between access points and stations in a wireless network. Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the present application provides a method of wireless communication. The method comprises, at a wireless device, transmitting, at a first power level, a first message to an access point. The method further comprises receiving one or more packets from the access point and from a plurality of stations. The method further comprises, based on the one or more packets, identifying first and second sets of stations of the plurality of stations, the first set of stations including a first station, and the second set of stations including a second station. The method further comprises, after identifying the first and second sets of stations, receiving an additional packet from the access point, the additional packet identifying the second station. The method further comprises, in response to receiving the additional packet, transmitting, at a second power level, a second message to the first station, the second power level being less than the first power level.

Another aspect of the present application provides an apparatus for wireless communication. The apparatus comprises a transmitter. The transmitter is configured to transmit, at a first power level, a first message to an access point. The apparatus further comprises a receiver. The receiver is configured to receive one or more packets from the access point and from a plurality of stations. The apparatus further comprises a processor. The processor is configured to, based on the one or more packets, identify first and second sets of stations of the plurality of stations, the first set of stations including a first station, and the second set of stations including a second station. The receiver is further configured to, after the processor identifies the first and second sets of stations, receive an additional packet from the access point, the additional packet identifying the second station. The transmitter is further configured to, in response to the receiver receiving the additional packet, transmit, at a second power level, a second message to the first station, the second power level being less than the first power level.

Yet another aspect of the present application provides an apparatus for wireless communication. The apparatus comprises means for transmitting, at a first power level, a first message to an access point. The apparatus further comprises means for receiving one or more packets from the access point and from a plurality of stations. The apparatus further comprises means for, based on the one or more packets, identifying first and second sets of stations of the plurality of stations, the first set of stations including a first station, and the second set of stations including a second station. The apparatus further comprises means for, after identifying the first and second sets of stations, receiving an additional packet from the access point, the additional packet identifying the second station. The apparatus further comprises means for, in response to receiving the additional packet, transmitting, at a second power level, a second message to the first station, the second power level being less than the first power level.

### BRIEF DESCRIPTION OF THE DRAWINGS

FIG. 1 illustrates a wireless communication system in which aspects of the present disclosure can be employed.

FIG. 2 illustrates various components that may be utilized in a wireless device that may be employed within the wireless communication system of FIG. 1.

FIG. 3 illustrates example message formats for messages transmitted or received by one or more wireless devices that may be employed within the wireless communication system of FIG. 1.

FIG. 4 illustrates an example network including example communication ranges for certain of the wireless devices that may be employed within the wireless communication system of FIG. 1.

FIG. 5 illustrates another set of communication ranges related to certain of the devices connected to an example network similar to that of the example network of FIG. 4.

FIG. 6 is a time sequence diagram of a method for wireless communication, in accordance with an implementation.

FIG. 7 is a flowchart of a method for wireless communication, in accordance with an implementation.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The word “exemplary” is used herein to mean “serving as an example, instance, or illustration.” Any implementation described herein as “exemplary’ is not necessarily to be construed as preferred or advantageous over other implementations. The following description is presented to enable any person skilled in the art to make and use the embodiments described herein. Details are set forth in the following description for purpose of explanation. It should be appreciated that one of ordinary skill in the art would realize that the embodiments may be practiced without the use of these specific details. In other instances, well known structures and processes are not elaborated in order not to obscure the description of the disclosed embodiments with unnecessary details. Thus, the present application is not intended to be limited by the implementations shown, but is to be accorded with the widest scope consistent with the principles and features disclosed herein

Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols.

In some implementations, a WLAN includes various devices which access the wireless access network. For example, there may be: access points (“APs”) and stations (also referred to as clients, wireless stations, user equipment, UEs, and STAs, among other names). In general, an access point serves as a hub, a router, or a base station for the stations in the WLAN. A station may be a laptop computer, a personal digital assistant (PDA), a mobile phone, a smart device, a smart appliance, or any type of computer-based device that can access the WLAN. In an example, a station connects to an access point via a Wi-Fi (e.g., IEEE 802.11 protocol such as 802.11ah) compliant wireless link to obtain general connectivity to the Internet, to one or more other stations and/or access points on the WLAN, or to other wide area access networks. In some implementations, a station may also be used as an access point.

In some aspects, wireless signals may be transmitted according to a high-efficiency 802.11 protocol using orthogonal frequency-division multiplexing (OFDM), direct-sequence spread spectrum (DSSS) communications, a combination of OFDM and DSSS communications, or other schemes. Implementations of the high-efficiency 802.11 protocol may be used for Internet access, sensors, metering, smart grid networks, or other wireless applications. Advantageously, aspects of certain devices implementing this particular wireless protocol may consume less power than devices implementing other wireless protocols, may be used to transmit wireless signals across short distances, and/or may be able to transmit signals less likely to be blocked by objects, such as humans.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). The cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). The cdma2000 is described in documents from an organization named “3rd Generation Partnership Project 2” (3GPP2). These various radio technologies and standards are known in the art.

The disclosed techniques may also be applicable to technologies and the associated standards related to LTE-A, LTE-U, LTE-D, LTE, MuLTEfire, W-CDMA, TDMA, OFDMA, High Rate Packet Data (HRPD), Evolved High Rate Packet Data (eHRPD), Worldwide Interoperability for Microwave Access (WiMax), GSM, enhanced data rate for GSM evolution (EDGE), and so forth. MuLTEfire is an LTE-based technology that solely operates in unlicensed spectrum, and does not require an “anchor” in licensed spectrum. Terminologies associated with different technologies can vary. LTE-D is a device-to-device technology that utilizes the licensed LTE spectrum and was released as part of 3GPP Release 12. LTE-D devices can communicate directly with other devices by sending a message in the network allocated slot and bandwidth. In some embodiments, depending on the technology considered, the station used in UMTS can sometimes be called a mobile station, a station, a user terminal, a subscriber unit, an access terminal, etc., to name just a few. Likewise, Node B used in UMTS can sometimes be called an evolved Node B (eNodeB or eNB), an access node, an access point, a base station (BS), HRPD base station (BTS), and so forth. It should be noted here that different terminologies apply to different technologies when applicable

The disclosed techniques may also be applicable to various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency-Division Multiple Access (OFDMA) systems, Single-Carrier Frequency-Division Multiple Access (SC-FDMA) systems, and so forth. An SDMA system may utilize sufficiently different directions to concurrently transmit data belonging to multiple user terminals. A TDMA system may allow multiple user terminals to share the same frequency channel by dividing the transmission signal into different time slots, each time slot being assigned to different user terminal. A TDMA system may implement GSM or some other standards known in the art. An OFDMA system utilizes orthogonal frequency-division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An OFDM system may implement IEEE 802.11 or some other standards known in the art. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. A SC-FDMA system may implement 3GPP-LTE (3rd Generation Partnership Project Long Term Evolution) or other standards.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal. An access point may comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Router, Radio Transceiver, Basic Service Set (“BSS”), Extended Service Set (“ESS”), Radio Base Station (“RBS”), or some other terminology. A station (“STA”) may also comprise, be implemented as, or known as a user terminal (“UT”), an access terminal (“AT”), a subscriber station, a client, a wireless client, a wireless station, a subscriber unit, a mobile station, a remote station, a remote terminal, a user agent, a user device, user equipment, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a smart device, a smart appliance, or any type of suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, a smart device, a smart appliance, or any other suitable device that is configured to communicate via a wireless medium.

It is well-known that in certain types of wireless networks, such as a WLAN, the wireless channel, or medium, may be used by only one station transmitter within range of the current transmission at any given time. For example, when one station on the WLAN transmits messages to an access point (e.g., a router) on the WLAN, the other stations on the WLAN cannot transmit at the same time. Furthermore, when an access point transmits over the WLAN, all of the stations within range prioritize receiving the transmission from the access point. That is, although only one station on the WLAN can transmit at one time, all of the devices on the WLAN may receive messages at the same time. And although transmission times are often short (e.g., on the order of microseconds to milliseconds), as the number of devices on the network increases, the likelihood of transmission interferences increases. Existing systems utilize certain mechanisms to reduce such network collisions. For example, systems utilize the well-known ready-to-send (RTS) and clear-to-send (CTS) mechanism for wireless medium reservation over particular time periods to reduce network collisions and increase quality-of-service (QoS) for the network.

However, as the number of devices connected to networks, such as WLANs, increases, so too do the network interferences and required idle times. For example, the quantity of so-called “Internet of Things” (also referred to as “IoT”) devices connected to any given network has increased in recent years. Smart refrigerators, smart thermostats, smart ovens, smart watches, smart microwaves, smart door locks, smart lightbulbs, smart TVs, and further network-connected devices of all kinds, mobile and stationary, small and large, can often total hundreds of devices connected to a network, such as a WLAN. Thus, when only one device on the network can transmit at any given time, the number of transmission interferences can increase greatly. Furthermore, each time an access point transmits a CTS over a network utilizing RTS and CTS schemes, each of the (possibly hundreds) of stations are prevented from transmitting during that time. These conditions result in poor overall utilization of the network channel medium, particularly in networks including several IoT devices.

Furthermore, many modern wireless transmission standards (e.g., IEEE 802.11n standards) institute systems for maximizing overall channel throughput, which can result in transmissions that span for hundreds of microseconds to several milliseconds. However, IoT devices often require real-time packet delivery with low latency (e.g., less than ten microseconds), despite utilizing small packet sizes (e.g., 100 bytes to 1,500 bytes without headers). Given these additional complications, and further in view of the issues introduced by the well-known hidden known problem in a WLAN, IoT devices are prone to experiencing frequent transmission failures, particularly when operating on crowded networks, as is often the case.

As mentioned above, on a traditional WLAN, when one device transmits (e.g., a station to an access point, or vice versa), the other stations within transmission range of the one station and/or the access point cannot also transmit at the same time. Traditionally, these stations will instead wait for their transmission turn, or idle, during this time. To maximize the utilization of the network channel medium, aspects of the present disclosure enable such stations to dynamically adjust their transmit power, thereby reducing their transmission range. This allows the reduced-power stations to utilize their otherwise idle time period to, for example, bypass communications with the access point and communicate directly (e.g., via WiFi Direct) with other nearby stations (e.g., stations on the same wireless channel and/or network). In short, the aspects of the present disclosure allow wireless clients on a network, such as a WLAN, to transmit signals simultaneously. In view of the many complications described above that IoT devices experience when operating on modern-day networks, such advantages can be particularly useful for networks that include one or more wireless IoT devices, which is common.

Although the embodiments described below convey aspects of the present disclosure from the perspective of a single access point on a WLAN, the aspects can be implemented and/or performed on any number of, or all of, the stations on a network, such as a WLAN. For example, each of the stations connected to a WLAN may incorporate the embodiments described below, for instance, as a one-time, preliminary configuration per station. Thereafter, each of the stations can benefit from the technical advantages. Furthermore, although the embodiments described below may be described with respect to a particular number of stationary IoT devices, the systems described herein may also be implemented on a lower or higher number of IoT devices, on any number of non-IoT devices, on any number of mobile IoT devices, and/or on any combination of network-based devices on any network. Finally, the descriptions of the embodiments below utilize several examples of particular IoT devices for ease of understanding. However, the example devices are in no way meant to limit the types of IoT devices, smart devices, or any other types of network-capable devices that may utilize and benefit from the embodiments described below.

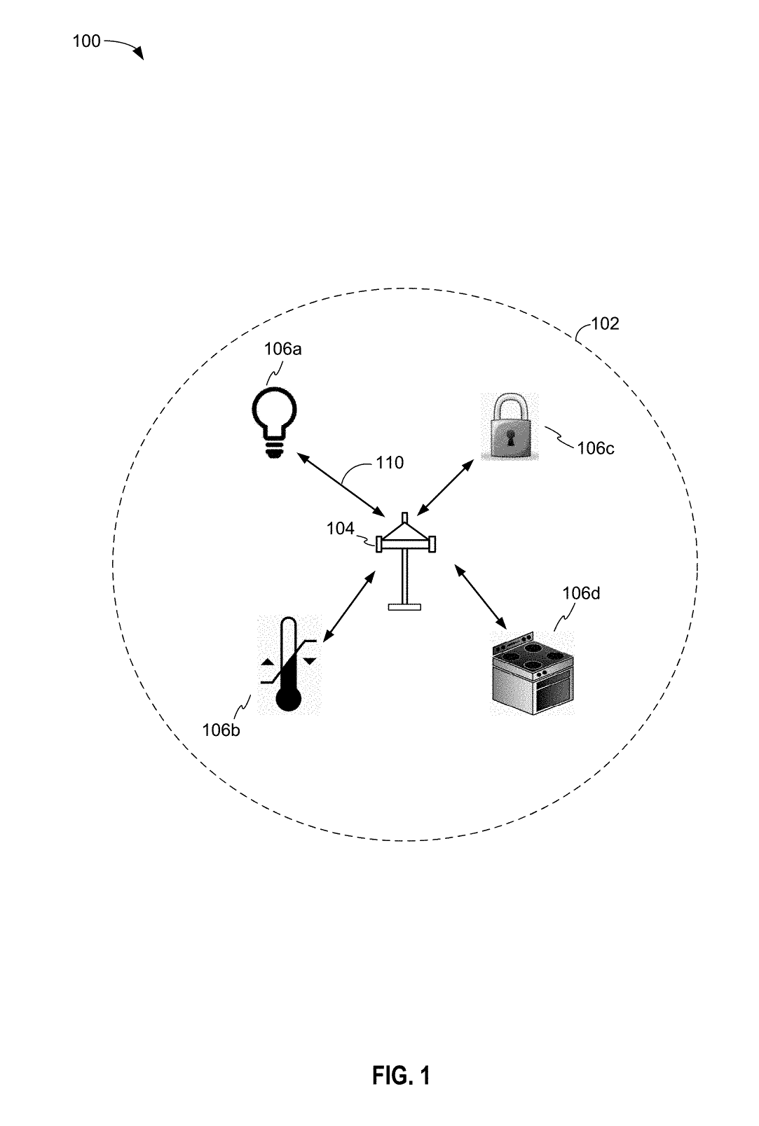

FIG. 1 illustrates a wireless communication system 100 in which aspects of the present disclosure can be employed. The wireless communication system 100 may operate pursuant to a wireless standard, for example, an 802.11ac standard or an 802.11n standard, among others. The wireless communication system 100 may include an access point 104, which communicates with stations 106a, 106b, 106c, and/or 106d, also individually or collectively referred to as the station 106 or the stations 106, respectively. The access point 104 and/or the stations 106 may also communicate with additional stations (not pictured). The stations 106 may also individually or collectively operate as an access point, or vice versa. The stations 106 may be in wireless communication with one or both of a cellular network (e.g., a 2G, 3G, 4G LTE, LTE-U, LTE-D, and/or MuLTEfire network) through the access point 104 or with a non-cellular network (e.g., wireless local area network (WLAN)) through the access point 104, or some other access point (not illustrated).

As mentioned, the wireless communication system 100 may include operation pursuant to a wireless standard, for example the 802.11ah, 802.11ac, 802.11n, 802.11g, 802.11b, or other 802.11 based standard. As shown, the access point 104 may provide communication coverage in a basic service area 102. For example, the access point 104 may function as a wireless router that serves various of the stations 106 within the basic service area 102. The station 106 may comprise a wireless device that is located within the basic service area 102. The stations 106 may communicate with the access point 104 over communication links 110. In one example, the communication link 110 can represent a WiFi signals being transmitted and/or received between one or more of the stations 106 and/or the access point 104. As another example, the communication link 110 can represent signals being sent and received between the access point 104 and the stations 106 in accordance with code division multiple access (CDMA) techniques. As another example, the stations 106 can communicate with the access point 104 via the communication link 110 using a cellular network (e.g., LTE), functioning as an LTE station. To these example ends, the communications exchanged between the stations 106 and/or the access point 104 in the wireless communication system 100 may include data units, which may comprise packets, frames, subframes, bits, etc. Furthermore, the devices may use any suitable network type and configuration, for example, those described above in the beginning paragraphs of the Detailed Description.

More specifically, a communication link that facilitates transmission from the access point 104 to one or more of the stations 106 can be referred to as a downlink (i.e., the portion of the communication link 110 that points at one of the stations 106), and a communication link that facilitates transmission from one or more of the stations 106 to the access point 104 can be referred to as an uplink (i.e., the portion of the communication link 110 that points at the access point 104). Alternatively, a downlink can be referred to as a forward link or a forward channel, and an uplink can be referred to as a reverse link or a reverse channel. The access point 104 may connect to one or more channels so as to communicate with the stations 106. The access point 104 may perform a channel identification procedure prior for connecting to one or more of the channels. The channel identification procedure and/or the channel connections may be subject to and operate in accordance with certain government regulations, e.g., DFS radar regulations.

The access point 104 may act as a base station, or a router, and provide wireless communication coverage in the basic service area 102. The access point 104 along with the stations 106 associated with the access point 104 and that use the access point 104 for communication can be referred to as a basic service set (BSS). It should be noted that, in some instances, the wireless communication system 100 may not have a central access point, but rather may function as a peer-to-peer network between the stations 106. Accordingly, the functions of the access point 104 described herein may alternatively be performed by one or more of the stations 106.

In some aspects, one of the stations 106 can be required to associate with the access point 104 in order to send communications to and/or receive communications from the access point 104. In one aspect, information for associating is included in a broadcast by the access point 104 (e.g., in a beacon; not pictured). To receive such a broadcast, the station 106 may, for example, perform a broad coverage search over a coverage region. A search may also be performed by the station 106 by sweeping a coverage region in a lighthouse fashion, for example. After receiving the information for associating, the station 106 may transmit a reference signal, such as an association probe or request, to the access point 104. In some aspects, the access point 104 may use backhaul services, for example, to communicate with a larger network, such as the Internet or a public switched telephone network (PSTN).

In an embodiment, the stations 106 may be IoT devices. For example, the station 106a can be a smart light bulb (or “smart bulb”), the station 106b can be a smart thermostat, the station 106c can be a smart door lock (or “smart lock”), and the station 106d can be a smart oven. In other words, each of these IoT devices can have network-enabled features that allow them to perform “smart” features via communicating with the access point 104, the Internet, and/or each other. To that end, one or more of the stations 106 may perform some or all of the operations described herein to enable simultaneous transmission by multiple stations at once. For example, station 106a may communicate with the access point 104 for a particular duration. Rather than waiting for them to finish, by utilizing the systems described below, the station 106b and the station 106d may be enabled to communicate directly with each other (e.g., via WiFi Direct and/or over the same wireless channel and/or network), bypassing communications with the access point 104, for the duration of the communications between the station 106a and the access point 104.

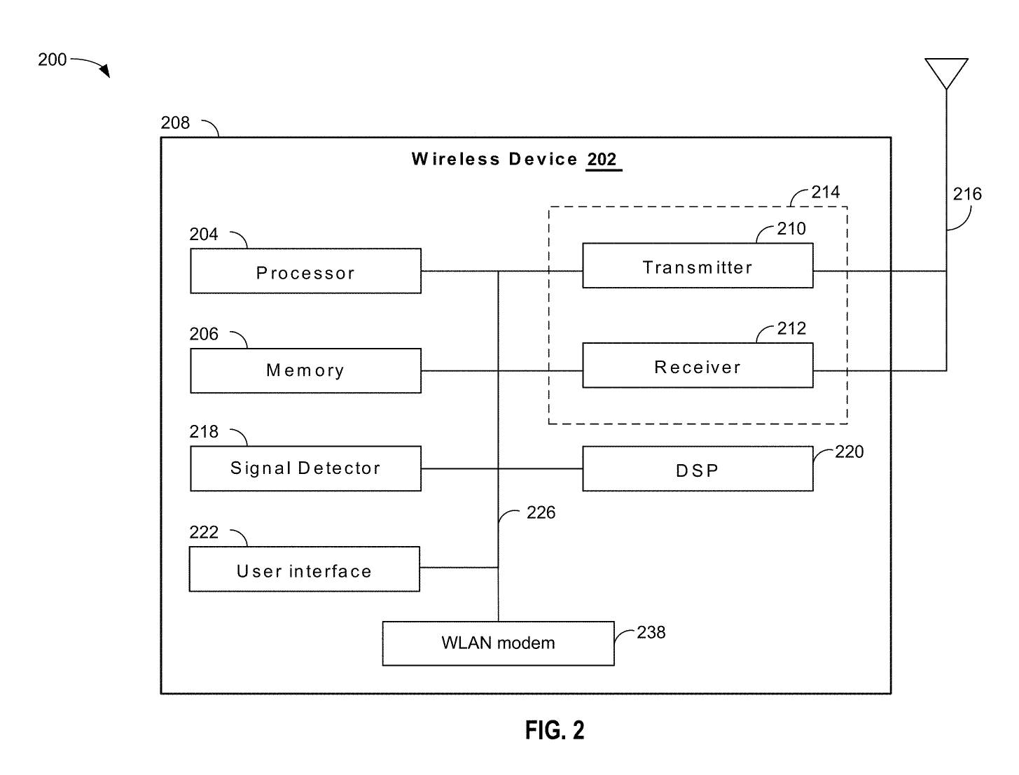

FIG. 2 illustrates various components that may be utilized in a wireless device 202 (e.g., the station 106b described in connection with FIG. 1) that may be employed within the wireless communication system 100 of FIG. 1. The wireless device 202 is an example of a device that can be configured to implement the various methods described herein. With respect to the description of FIG. 2 herein, some of the item numbers may refer to the so-numbered aspects described above in connection with FIG. 1. For example, the wireless device 202 may comprise one of the stations 106 and/or the access point 104.

The wireless device 202 may include a processor 204 which controls operation of the wireless device 202. The processor 204 may also be referred to as a central processing unit (CPU) or hardware processor. Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein. Furthermore, the wireless device 202 may utilize the memory 206 to store information about other devices on the network to enable the use of certain methods described below, e.g., storing identifiers for particular stations and/or characteristics for stations on the network. The wireless device 202 may then utilize the processor 204 in connection with the memory 206 to analyze the stored data and determine and/or identify various sets, categories, distance characteristics, or otherwise, for the access point 104 or one or more of the stations 106 on the network.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include non-transitory machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein. The processor 204 may further comprise a packet generator to generate packets for controlling operation and data communication.

The wireless device 202 may include a transmitter 210 and a receiver 212 to allow transmission and reception of data between the wireless device 202 and a remote location. The transmitter 210 and the receiver 212 may be combined into a transceiver 214. An antenna 216 may be electrically coupled to the transceiver 214. The wireless device 202 may also include (not shown) multiple transmitters, multiple receivers, multiple transceivers, and/or multiple antennas, which may be utilized during multiple-input multiple-output (MIMO) communications, for example. In some embodiments, each of the multiple antennas may be dedicated for the transmission and/or reception of LTE-U, LTE-D, MuLTEfire, and/or WLAN communications. The wireless device may be covered by a housing unit 208.

The wireless device 202 also comprises a WLAN modem 238 for communicating with WLAN devices. For example, the WLAN modem 238 can enable the wireless device 202 to send, receive, and process WLAN communications. The WLAN modem 238 may contain processing capabilities to operate in both the physical (PHY) layer and the medium access control (MAC) layer for WLAN.

The wireless device 202 may also include a signal detector 218 that may be used in an effort to detect and quantify the level of signals received by the antenna 216, the transmitter 210, the receiver 212, or the transceiver 214. The signal detector 218 may detect such signals in a form of detecting total energy, energy per subcarrier per symbol, power spectral density and others. The wireless device 202 may also include a digital signal processor 220 (which can also be referred to as a “DSP”) for use in processing signals. The digital signal processor 220 may be configured to generate a data unit for transmission. In some aspects, the data unit may comprise a physical-layer protocol data unit (PPDU). In some aspects, the PPDU is referred to as a packet. The digital signal processor 220 may be operationally connected to the processor 204 and may share resources with the processor 204.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

Various components of the wireless device 202 may be coupled together by a bus system 226. The bus system 226 may include a data bus, for example, as well as a power bus, a control signal bus, and a status signal bus in addition to the data bus. Those of skill in the art will appreciate various components of the wireless device 202 may be coupled together or accept or provide inputs to each other using some other mechanism.

Although a number of separate components are illustrated in FIG. 2, those of skill in the art will recognize that one or more of these components may be implemented not only with respect to the functionality described above, but also to implement the functionality described above with respect to other components. For example, the processor 204 may be used to implement not only the functionality described above with respect to the processor 204, but also to implement the functionality described above with respect to the signal detector 218 and/or the digital signal processor 220. Each of the components illustrated in FIG. 2 may be implemented using a plurality of separate elements.

As noted above, the wireless device 202 may comprise the access point 104 or the station 106, and may be used to transmit and/or receive communications over licensed or unlicensed spectrums. Specifically, in a non-limiting example, the access point 104 or the station 106 may comprise a WLAN configured to operate on a network with one or more IoT devices present.

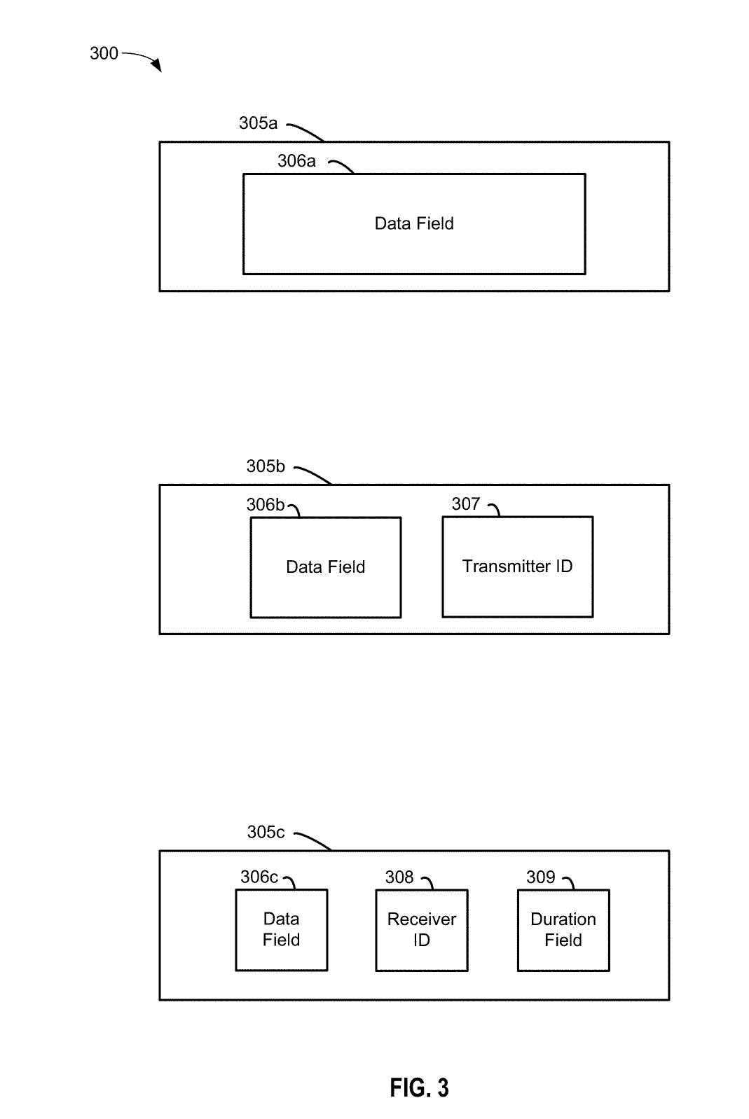

FIG. 3 illustrates example message formats 300 for messages transmitted or received by one or more wireless devices that may be employed within the wireless communication system 100 described in connection with FIG. 1. With respect to the description of FIG. 3 herein, some of the item numbers may refer to the so-numbered aspects described above in connection with one or more of FIGS. 1 and 2. For example, devices (e.g., the access point 104, the stations 106, etc.) can send messages to one another within a basic service area (e.g., the basic service area 102) via various communication links (e.g., the communication link 110) utilizing, for example, the various components of the wireless device 202.

To that end, FIG. 3 illustrates example message 305a, which is a generic message that could comprise any type of message (e.g., CTS, RTS, ACK, etc.) and include any combination of types and numbers of packets, fields, data, etc., as represented by a data field 306a. The data field 306a may not necessarily be a field, depending on the type of data transfer. For example, the data field 306a may include a plurality of fields or one or more packets, headers, values, flags, etc., or any combination thereof.

Types of information that may be included in the message 305a, relevant to the examples herein, include, for example, a transmitter identifier, a receiver identifier, and/or a duration field. Thus, a second example message (i.e., a RTS 305b) is illustrated in FIG. 3, which includes a transmitter identifier 307, and a third example message (i.e., a CTS 305c) includes a receiver identifier 308 and a duration field 309. A data field 306b of the RTS 305b and a data field 306c can include properties similar to those described above with respect to the data field 306a. In some aspects, the RTS 305b may also include a duration field (not pictured) similar to that of the duration field 309 of the CTS 305c.

As an illustrative example, if the station 106b wants to communicate with the access point 104 within the basic service area 102 and over the wireless communication system 100 (e.g., a WLAN), the station 106b may transmit a ready-to-send message (e.g., the RTS 305b) to the access point 104. So that the access point 104 knows where the RTS 305b came from, the RTS 305b can include a transmitter identifier (e.g., the transmitter identifier 307), which may comprise any appropriate type of identifier that identifies the station 106b. As one example, the transmitter identifier 307 included in the RTS 305b transmitted from the station 106b could comprise a MAC address of the station 106b. In this example, because the station 106a, the station 106c, and the station 106d are all within range of these communications, each of the station 106a, the station 106c, and the station 106d will also receive the RTS 305b. In this way, each of the access point 104, station 106a, the station 106c, and the station 106d can become aware of the presence of the station 106b within the basic service set of the basic service area 102.

Continuing with this example, if network conditions permit, in response to receiving the RTS 305b from the station 106b, the access point 104 may transmit a clear-to-send message (e.g., the CTS 305c) to the station 106b. In this example, any number of other messages could be transmitted and/or any number of network activities could occur between the transmission of the RTS 305b and the transmission of the CTS 305c. Continuing with this example, so that the station 106b knows that the CTS 305c is addressed to the station 106b, the CTS 305c can include a receiver identifier (e.g., the receiver identifier 308), which may comprise any type of identifier for the station 106b. For example, the receiver identifier 308 included in the CTS 305c sent from the access point 104 to the station 106b may comprise the MAC address of the station 106b, similar to that of the transmitter identifier 307 included in the RTS 305b sent from the station 106b to the access point 104. And again, each of the station 106a, the station 106c, and the station 106d, if within range, will also receive the CTS 305c in this example.

As discussed above, due to the nature of certain networks (e.g., a WLAN), when each of the station 106a, the station 106c, and the station 106d receive the CTS 305c from the access point 104, each of the station 106a, the station 106c, and the station 106d traditionally will stop transmitting over the basic service area 102 so as to allow for the access point 104 and the station 106b to communicate without interference. To that end, the CTS 305c can further include a duration value (e.g., a duration field 309), which indicates an amount of time for the devices on the network to wait and/or idle. The duration field 309 can comprise any type of indicator for a time duration, including indicators that are not fields (e.g., simply one or more values in any form). For example, when receiving the CTS 305c addressed to the station 106b from the access point 104, each of the station 106a, the station 106c, and the station 106d may set a wait or idle counter (e.g., a network allocation vector, or “NAV”). In this example, traditionally, when the counter, or NAV, reaches zero, each of the station 106a, the station 106c, and the station 106d will no longer be required to refrain from transmission. As discussed above, the wait time, although small, may be too long for some devices (e.g., IoT devices) that require low latency packet delivery, causing the devices to have failed communications. For example, the wait times may cause communications between the devices to be delayed (e.g., for several seconds), which can negatively impact or defeat the purposes of the communications. Furthermore, as the number of devices (e.g., IoT devices) increases, such delays may compound, further increasing the network delay. Thus, if many devices are present on the network, the network delay may increase to several seconds, which as discussed above, is undesirable, particularly for IoT devices.

Thus, with reference to the example above, aspects of the present disclosure instead enable any or all of the station 106a, the station 106c, the station 106d, or any other device on the network to instead utilize this idle time to communicate directly with each other during the duration indicated in the duration field 309 of the CTS 305c transmitted from the access point 104 to the station 106b. Similarly, when any other of the stations 106 (e.g., the station 106c) communicate with the access point 104 for a duration (e.g., based on the duration field 309 included in the CTS 305c), aspects of the present disclosure can enable any other of the stations 106 (e.g., the station 106b) to directly communicate with each other. The extent to which the stations 106 can directly communicate with each other while the access point 104 communicates with another device is based on the relative location of the stations 106 and the access point 104 to one another and their communication ranges at any particular time.

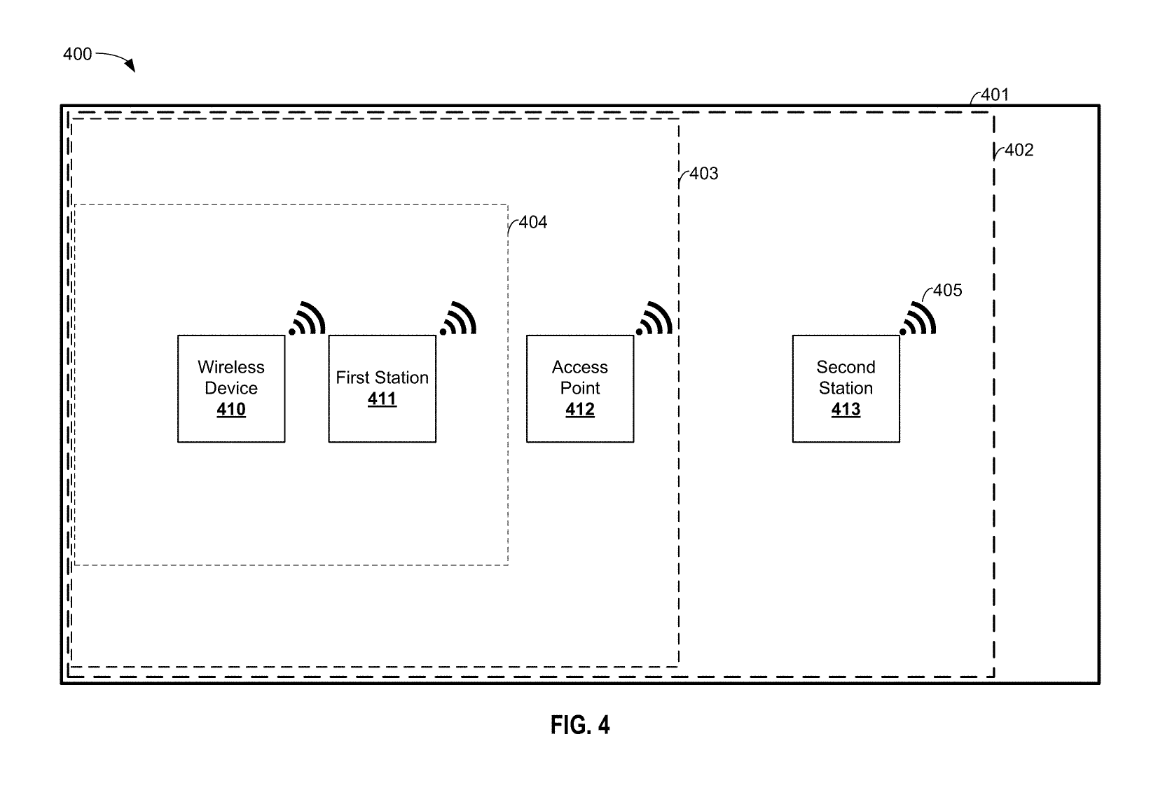

Thus, FIG. 4 illustrates an example network 400 (e.g., a WLAN) including example communication ranges for certain of the wireless devices that may be employed within the wireless communication system of FIG. 1. With respect to the description of FIG. 4 herein, some of the item numbers may refer to the so-numbered aspects described above in connection with one or more of FIGS. 1-3. For example, FIG. 4 illustrates a basic service area 401, which may be functionally similar to the basic service area 102. Furthermore, FIG. 4 illustrates various devices (e.g., a wireless device 410, a first station 411, an access point 412, and a second station 413), which may be functionally similar to one or more of the access point 104 or any of the stations 106, all of which may include any of the various components of the wireless device 202, and all of which may send or receive messages such as the message 305a, the RTS 305b, and/or the CTS 305c. The possibility for message transmissions or receptions by any of the wireless device 410, the first station 411, the access point 412, and/or the second station 413 is represented by a signal 405.

In one non-limiting example, the access point 412 may be a wireless router, and each of the wireless device 410, the first station 411, and the second station 413 may be stationary “smart” devices (i.e., Internet of Things “IoT” devices), which as discussed above, typically benefit from low latency transmission times. In this example, as illustrated, the distance from the wireless device 410 to the first station 411 is shorter than the distance from the wireless device 410 to either of the access point 412 and the second station 413. Further in this example, the distance from the wireless device 410 to the access point 412 is shorter than the distance from the wireless device 410 to the second station 413.

Continuing this non-limiting example, the wireless device 410 could be a smart thermostat, for example, a thermostat that connects to the WLAN to send and receive communications related to temperature within the building. As another non-limiting example, the first station 411 could be a smart oven, for example, an oven that connects to the WLAN to send and receive communications related to functionalities and settings for the oven, e.g., preheat, temperature levels, timers, etc. In this example, it may be beneficial for the wireless device 410 and the first station 411 to communicate with one another. For instance, the first station 411 may notify the wireless device 410 that the first station 411 is preheating and that the temperature of the building will soon increase. In this way, the wireless device 410 could, for example, turn on the air-conditioning immediately, so as to stay ahead of the impending temperature increases, keeping the building at a constant temperature. In this example, it may not be necessary for either of the wireless device 410 or the first station 411 to communicate with the access point 412 to accomplish this task, i.e., the wireless device 410 and the first station 411 can directly communicate (e.g., via WiFi Direct) with each other and temporarily bypass communications with the access point 412.

To continue this non-limiting example, the second station 413 could be a smart lock, for example, a door lock that connects to the WLAN to send and receive communications related to locking or unlocking the door on which the lock is installed. To that end, at certain times, the second station 413 may communicate with the access point 412. And as discussed above, a station (e.g., the second station 413) typically communicates with an access point (e.g., the access point 412) for a defined duration, which may be indicated in a message sent from the access point 412 to the second station 413 (e.g., indicated in the duration field 309 included in the CTS 305c transmitted via the signal 405).

Beneficially, with reference to this non-limiting example, aspects of the present disclosure can enable any of the other stations (e.g., the wireless device 410 and/or the first station 411) to directly communicate with each other for the duration set forth in the duration field 309. As discussed above, such direct communications can be useful, particularly for IoT devices. To that end, for the duration that the second station 413 and the access point 412 communicate, aspects of the present disclosure can enable, in this example, one or both of the wireless device 410 and the first station 411 to decrease their transmission power, thereby decreasing their communication range (or “transmission range,” “listening range,” “sensing range,” “receiving range,” etc.) and allowing one or both of the wireless device 410 and the first station 411 to bypass communications with the access point 412 and/or the second station 413, and instead communicate directly with one another.

As a simplified example, FIG. 4 further illustrates example communication ranges within the basic service area 401 when the wireless device 410 operates at different, adjusted power levels. For example, a first power level area 403 can be a communication range for the wireless device 410 when, in this example, the wireless device 410 operates at a first power level. When operating at this level, for example, the wireless device 410 can send and receive messages with the first station 411 and the access point 412; however, the wireless device 410 cannot receive messages from the second station 413. A second power level area 404 can be a communication range for the wireless device 410 when the wireless device 410 operates at a second power level, the second power level being lower than that of the first power level (e.g., by 2-3 decibels or “dB”). When operating at this level, for example, the wireless device 410 can send and receive messages with the first station 411; however, the wireless device 410 cannot receive messages from the access point 412 or the second station 413. Finally, a third power level area 402 can be a communication range for the wireless device 410 when the wireless device 410 operates at a third power level, the third power level being greater than both the first and second power levels (e.g., by 2-3 dB and 4-6 dB, respectively). When operating at this level, for example, the wireless device 410 can send and receive messages with the first station 411, the access point 412, and the second station 413. In one aspect, the third power level may be the maximum power level (e.g., 20 dB) for the wireless device 410. The power levels can be of any other values, higher or lower.

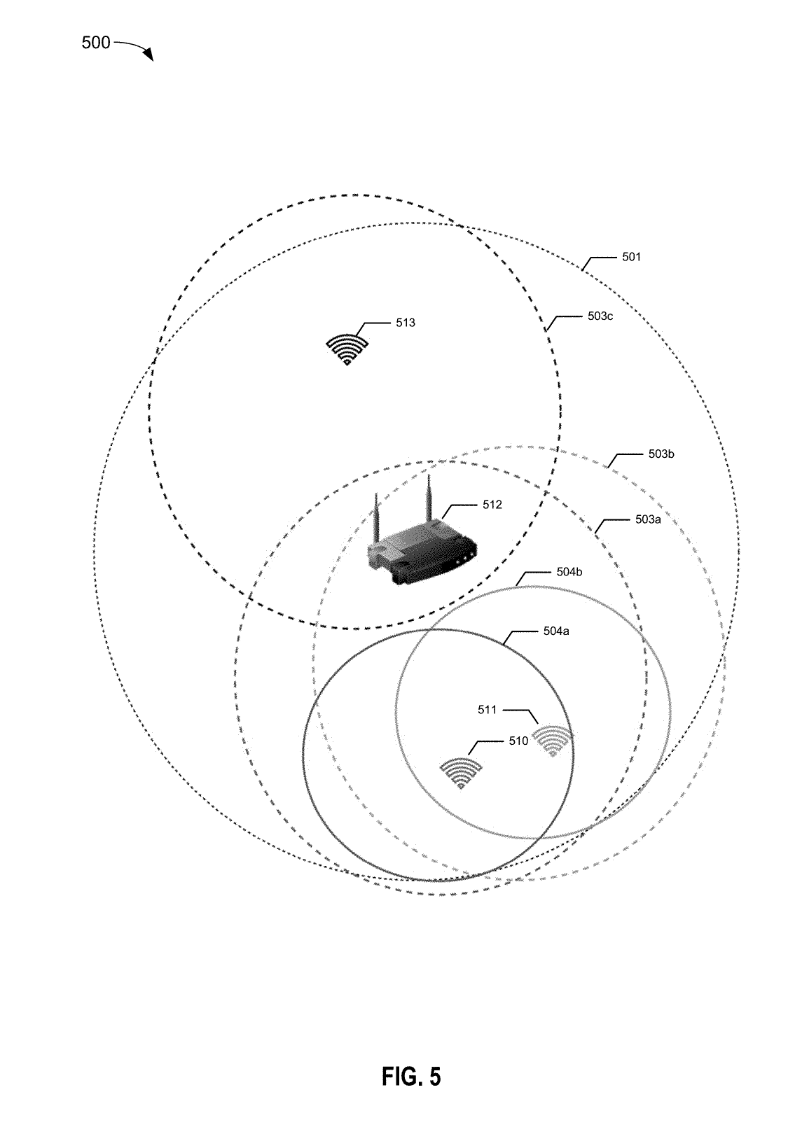

One having ordinary skill in the art will understand that wireless communication ranges are not typically of rectangular shape, as illustrated in the simplified examples of FIG. 4. Thus, FIG. 5 illustrates another set of communication ranges related to certain of the devices connected to an example network (e.g., an example network 500) similar to that of the example network 400 described in connection with FIG. 4. One having ordinary skill in the art will understand that the communication ranges are not drawn to-scale and are for illustrative purposes only. With respect to the description of FIG. 5 herein, some of the item numbers may refer to the so-numbered aspects described above in connection with one or more of FIGS. 1-4.

To that end, FIG. 5 includes a basic service area 501, a wireless device 510, a first station 511, a access point 512, and a second station 513, which may generally correspond to the basic service area 401, the wireless device 410, the first station 411, the access point 412, and the second station 413, described in connection with FIG. 4, respectively. FIG. 5 further includes a first power level area 503a and a second power level area 504a, which may generally correspond to the first power level area 403 and the second power level area 404, described in connection with FIG. 4, respectively.

FIG. 5 also illustrates a first power level area 503b and a second power level area 504b, which may generally correspond to the first power level area 503a and the second power level area 504a, except as from the perspective of the first station 511, rather than from the perspective of the wireless device 510. In addition, FIG. 5 illustrates a first power level area 503c, which may generally correspond to the first power level area 503a, except as from the perspective of the second station 513, rather than from the perspective of the wireless device 510.

Thus, in addition to the second station 513, either or both of the first station 511 and the wireless device 510 (or any other station(s) on the network (not pictured)) may utilize the aspects of the present disclosure to directly communicate with other devices on the network when a different station (e.g., the second station 513) is communicating with the access point 512.

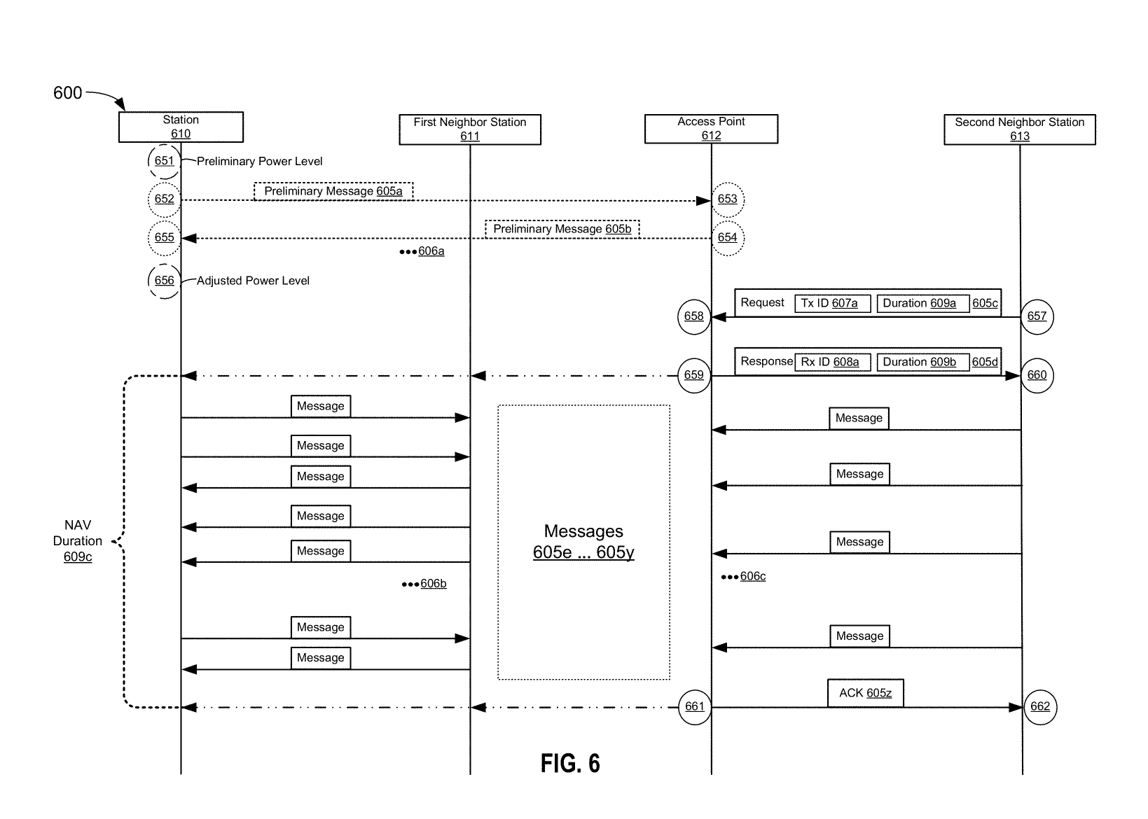

FIG. 6 is a time sequence diagram 600 of a method for wireless communication, in accordance with an implementation. With respect to the description of FIG. 6 herein, some of the item numbers may refer to the so-numbered (or differently numbered) aspects described above in connection with one or more of FIGS. 1-5. To that end, FIG. 6 includes a station 610, a first neighbor station 611, an access point 612, and a second neighbor station 613, which may generally correspond to any one of the stations 106 (and thus, the wireless device 410 or the wireless device 510), the first station 411 (or the first station 511), the access point 412 (or the access point 512), and the second station 413 (or the second station 513), respectively. Thus, each of the station 610, the first neighbor station 611, the access point 612, and the second neighbor station 613 may transmit and receive messages to and from one another, for example, any of the message 305a, the RTS 305b, the CTS 305c, or any other message, packet, communication, or otherwise. Furthermore, one or more of the station 610, the first neighbor station 611, the access point 612, and the second neighbor station 613 may be connected to a network (e.g., a WLAN), similar to that as illustrated in FIG. 1. Finally, one or more of the station 610, the first neighbor station 611, the access point 612, and the second neighbor station 613 may include and utilize various components for communications, for example, the components described in connection with FIG. 2.

As a non-limiting example for purposes of the following further description of FIG. 6, and similar to the example described above with respect to FIGS. 4 and 5, the access point 612 may be a wireless router, and the station 610, the first neighbor station 611, and the second neighbor station 613, may be stationary smart devices (e.g., IoT devices), for example, a smart thermostat, a smart oven, and a smart lock, respectively. Continuing this non-limiting example, similar to the examples of FIGS. 4 and 5, as illustrated, the distance from the station 610 to the first neighbor station 611 is shorter than the distance from the station 610 to either of the access point 612 and the second neighbor station 613. Further in this example, the distance from the station 610 to the access point 612 is shorter than the distance from the station 610 to the second neighbor station 613.

To continue with this example, at state 651, the station 610 may start at a preliminary power level. For example, the station 610 may start at a maximum power level (e.g., 20 dB) and have the ability to communicate within a particular power level area (e.g., the third power level area 402) that includes all of the first neighbor station 611, the access point 612, and the second neighbor station 613. Thus, the station 610 may consider the first neighbor station 611 and the second neighbor station 613 as neighboring clients, or “neighbors.” In some embodiments, the station 610 can store a list of neighbors in a memory (e.g., the memory 206) of the station 610.

All of the communications described below with respect to FIG. 6 can occur in any number of differing orders, one or more of the communications may not occur at all, and one or more additional communications may occur, all depending on the activities and states of the network (e.g., the WLAN) and the devices (e.g., the station 610, the first neighbor station 611, the access point 612, the second neighbor station 613, and any other devices) connected therein. Although the below examples describe certain messages, transmissions, receptions, requests, responses, identifications, establishments, additional messages, and durations occurring in a particular order, the example order is for simplified, illustrative purposes only. Furthermore, one having ordinary skill in the art will understand that certain of the messages of the examples below are optional and are further for illustrative, non-limiting example purposes only. Finally, although the below examples describe communications from the perspective of one station (e.g., the station 610), one having ordinary skill in the art will understand that the concepts can be applied to one or more of the other stations (e.g., the first neighbor station 611 and/or the second neighbor station 613) or any number of other stations on the network and/or the same channel (not pictured).

The station 610 may first determine a communications range that excludes stations further from the station 610 than the access point 612. To achieve this, at transmission 652, the station 610 may send a preliminary message 605a that the access point 612 receives at reception 653. The preliminary message 605a, and any other of the messages described herein may be similar to the message 305a and, in some cases, may also include any of the aspects discussed above with respect to the message 305a, the RTS 305b, the CTS 305c, and/or any other messages described herein, and such messages may also be referred to herein as “preliminary communications,” “preliminary messages,” “one or more preliminary communications,” or “one or more preliminary messages.” In response to receiving preliminary message 605a, the access point 612 may send a preliminary message 605b to the station 610 at transmission 654, which the station 610 may receive at reception 655. The preliminary message 605b may include one or more error indications that can inform the station 610 as to the current quality of communications between the station 610 and the access point 612. If the quality is more than sufficient, then the station 610 can decrease its power level to determine if a lower power level will also result in sufficient communications with the access point 612. Then, at period 606a, the station 610 may repeat this process and adjust its power level for each message exchange until the station 610 determines a minimum power level required for messages transmitted from the station 610 to reach the access point 612 without error, thereby determining a first power level (not pictured). The first power level may generally correspond to the first power level that allows for the wireless device 410 to operate in the first power level area 403 as described in connection with FIG. 4.

Although not pictured, any number of additional message and/or device events may occur during the period 606a before the station 610 reaches a state 656, as further discussed below, for example based on the one or more additional messages. For example, having established the first power level, the station 610 may then transmit one or more messages to the access point 612 at the first power level. For example, the station 610 may transmit a first message to the access point 612. In one embodiment, the first message can include a transmitter identifier (e.g., a media access control (“MAC”) address) for the station 610. The first message can also be any other message, including one of the messages discussed above with respect to the preliminary message 605a for determining the first power level. In some embodiments, the station 610 may not send any further messages to the access point 612 after establishing the first power level. In a similar fashion, during the period 606a, the first neighbor station 611 may transmit a request message (e.g., similar to that of the RTS 305b) to the access point 612, with the request message including a transmitter identifier (e.g., a MAC address) for identifying the first neighbor station 611. As discussed above, stations within range of the request message may also receive the request message and the transmitter identifier transmitted from the first neighbor station 611. In this example, the station 610, operating at the first power level can receive the request message including the transmitter identifier. In one embodiment, the station 610 can store the transmitter identifier for the first neighbor station 611 in the memory 206 for purposes of further identifying a set of neighbor stations. In a similar fashion, during the period 606a, the second neighbor station 613 may transmit a request message (e.g., similar to that of the RTS 305b) to the access point 612, with the request message including a transmitter identifier (e.g., a MAC address) for identifying the second neighbor station 613. As discussed above, stations within range will also receive the request message and the transmitter identifier from the second neighbor station 613. In this example, the station 610, operating at the first power level, will not receive the request message from the second neighbor station 613, and will thus not receive the transmitter identifier from the second neighbor station 613 at this time.

As discussed above, based on the conditions of the network and the devices connected thereto, various communications can occur during a period 606b, in addition to the period 606a, a period 606c, a period 606d, among any other points on the time sequence diagram 600. Again, the order and quantity of the messages described with respect to FIG. 6 are for simplified example purposes only. For example, continuing with the period 606a, at varying times that can differ from the order illustrated, the access point 612 can transmit various responses messages (e.g., similar to that of the CTS 305c) to one or more of the station 610, the first neighbor station 611, and/or the second neighbor station 613. As discussed above, stations within range of any of the various response messages may also receive the corresponding messages for those transmissions. Thus, in this example, because the station 610 is operating at the first power level, the station 610 may receive receiver identifiers (e.g., similar to the receiver identifier 308) for both the first neighbor station 611 and the second neighbor station 613, to be stored (e.g., in the memory 206) at the station 610. With this information, the station 610 may identify first and second sets of stations from among the neighbors on the client list described above. For example, continuing the above non-limiting example, the client list stored at the station 610 may now include the MAC address for the first neighbor station 611 and the MAC address for the second neighbor station 613. Based on the stored addresses, the station 610 may then determine which, if any, of the stored transmitter identifiers match with which, if any, of the stored receiver identifiers. In this example, the station 610 may determine that the stored transmitter identifier for the first neighbor station 611 matches with the stored receiver identifier for the first neighbor station 611. Thus, the station 610 may identify the corresponding station, the first neighbor station 611, as part of the first set of stations. The first set of stations can be considered to have a first distance characteristic, in this case, that the first set of stations are “adjacent” to the station 610. Thus, the station 610 may identify the first neighbor station 611 as an “adjacent neighbor.” Further in this example, the station 610 may determine that there are no matching transmitter identifiers for the receiver identifier for the second neighbor station 613. Thus, in one embodiment, the station 610 may identify the corresponding station, the second neighbor station 613, as part of the second set of stations. The second set of stations can be considered to have a second distance characteristic, in this case, that the second set of stations are “distant” from the station 610. In this way, the station 610 may determine the second set of stations. Thus, the station 610 may identify the second neighbor station 613 as a “distant neighbor.” In this way, the first and second sets of stations will be mutually exclusive. In one embodiment, the station 610 may continue in this way for additional stations on the WLAN (not pictured), while continuing to add the additional stations to either the first or second sets of stations according to the matching techniques described above. Based on one or more indications and/or determinations at the station 610, the station 610 may arrive at an adjusted power level at a state 656, as further discussed below. The adjusted power level for the station 610 may be set at the state 656 or it may be set at any other point before a duration 609c, as further discussed below.

Continuing with this non-limiting example, after any number of additional communications among one or more of the devices of FIG. 6, at a transmission 657, the second neighbor station 613 may transmit a request message 605c to the access point 612, which the access point 612 may receive at a reception 658. The request message 605c can be similar to the RTS 305b in some aspects. The request message 605c may include a transmitter identifier 607a for identifying the second neighbor station 613 (e.g., via a MAC address for the second neighbor station 613). The request message 605c may also include a duration 609a (e.g., a time duration similar to that described in connection with the duration field 309 of FIG. 3), for example, for identifying an amount of time that the second neighbor station 613 desires to communicate with the access point 612. As the second neighbor station 613 is a “distant neighbor” (from the perspective of the station 610) in this example, the station 610 may not receive the request message 605c or its contents.

Thereafter, the access point 612, at a transmission 659, may transmit a response message 605d (e.g., a message similar to the CTS 305c) to the second neighbor station 613, for reception at the second neighbor station 613 at a reception 660. The response message 605d can include, for example, a receiver identifier 608a (e.g., the MAC address of the second neighbor station 613) and a duration 609b (e.g., a time duration similar to that described in connection with the duration field 309 of FIG. 3) corresponding to the duration 609a. Similarly, as discussed above, stations within range of the access point 612 (e.g., the station 610 and the first neighbor station 611) will also receive the receiver identifier 608a of the response message 605d sent from the access point 612, as indicated by the dashed lines extending left from the transmission 659. Thus, the station 610 can determine that the access point 612 is communicating with a station from the second set of stations (e.g., a “distant neighbor,” for example, the second neighbor station 613). In an embodiment, so as to enable the station 610 to directly communicate with one or more of the stations from the first set of stations (e.g., the “adjacent neighbors”) during communications between the access point 612 and the second neighbor station 613, the station 610 may further decrease the power level at the station 610 (e.g., by an additional 2-3 dB), for example, further adjusting the “adjusted power level” described with respect to state 656. The adjusted power level may be similar to the second power level area 404 described in connection with FIG. 4. That is, while operating at the adjusted power level, in this example, the first neighbor station 611 will be within the transmission range of the station 610, and both the access point 612 and the second neighbor station 613 will not be within the transmission range of the station 610.

Continuing with this example, the access point 612 and the second neighbor station 613 may then communicate for an identified duration (e.g., the duration identified by the duration 609a). This duration is illustrated by the dashed curly bracket at a duration 609c. In one aspect, one or both of the station 610 and the first neighbor station 611 may monitor the duration according to a NAV, as discussed above. One having ordinary skill in the art will understand that the duration 609c, as illustrated, is not to scale. During the duration 609c, as illustrated by messages 605e-605y (i.e., any number of messages during the duration 609c, as indicated by a period 606b and a period 606c), and while operating at the adjusted power level, the station 610 can exchange messages with stations of the first set of wireless stations (e.g., the first neighbor station 611 or “adjacent stations”), bypassing (and not interrupting) communications between the access point 612 and the second neighbor station 613. The messages 605e-605y may comprise any of the messages described in connection with FIG. 3, or any other message that one having ordinary skill in the art would understand as being exchanged between a station and/or an access point. At the same time (during the duration 609c), the access point 612 and the second neighbor station 613 may also communicate uninterrupted, as illustrated. In some aspects, any other combination or order of messages exchanges may occur during the duration 609c. The illustrated example messages 605e-605y are, in no way, limiting examples of how messages may be sent and/or received between the station 610 and the first neighbor station 611, between the access point 612 and the second neighbor station 613, or between any other appropriate adjacent devices that meet the conditions described above (not pictured), during the duration 609c (e.g., the NAV duration). In an embodiment, the duration 609c (e.g., the NAV) may end at a transmission 661, when the access point 612 sends an acknowledgement message 605z (e.g., an ACK) to the second neighbor station 613 for reception at a reception 662. Similar to the response message 605d discussed above, in some aspects, stations in range (e.g., the station 610 and the first neighbor station 611) may also receive the acknowledgement message 605z, as indicated by the dashed lines extending left from the transmission 661.

In an embodiment, after the duration 609c, the station 610 may return to the first power level (not pictured) or any other power level. Thereafter, the station 610 may continue to operate at the first power level (e.g., one that includes the access point 612 within range) until the station 610 senses a subsequent receiver identifier (e.g., the receiver identifier 608d or a receiver identifier for another distant neighbor (not pictured)) for another station included in the second set of stations (e.g., the “distant neighbors”). When this occurs, the station 610 (and any other devices, as applicable) may return to the adjusted power level (e.g., similar to the state 656) to directly communicate (e.g., via WiFi Direct over the same channel and/or network) among members of the first set of stations (e.g., the “adjacent neighbors”), bypassing the access point 612 that is communicating with one of the stations of the second set of stations (e.g., the second neighbor station 613 or an “adjacent station”), and then return to the first power level after the duration indicated in the message including the subsequent receiver identifier.

Thus, in accordance with the above examples, contrary to existing systems, the station 610 (and the first neighbor station 611, among other devices, as applicable) will be enabled to transmit even while another station (e.g., the second neighbor station 613) transmits over the WLAN (e.g., to the access point 612). Advantageously, particularly for Internet of Things (IoT) devices that commonly utilize small data transmissions, these durations will be adequate for successfully completing direct communications (e.g., via WiFi Direct) with neighboring clients. For example, while the access point 612 (e.g., a wireless router) communicates with the second neighbor station 613 (e.g., a smart lock) over the network (e.g., a WLAN), the first neighbor station 611 (e.g., a smart oven) can communicate directly (e.g., via WiFi Direct) with the station 610 (e.g., a smart thermostat) to coordinate adjusting the building temperature in response to putting the oven in a preheating mode.

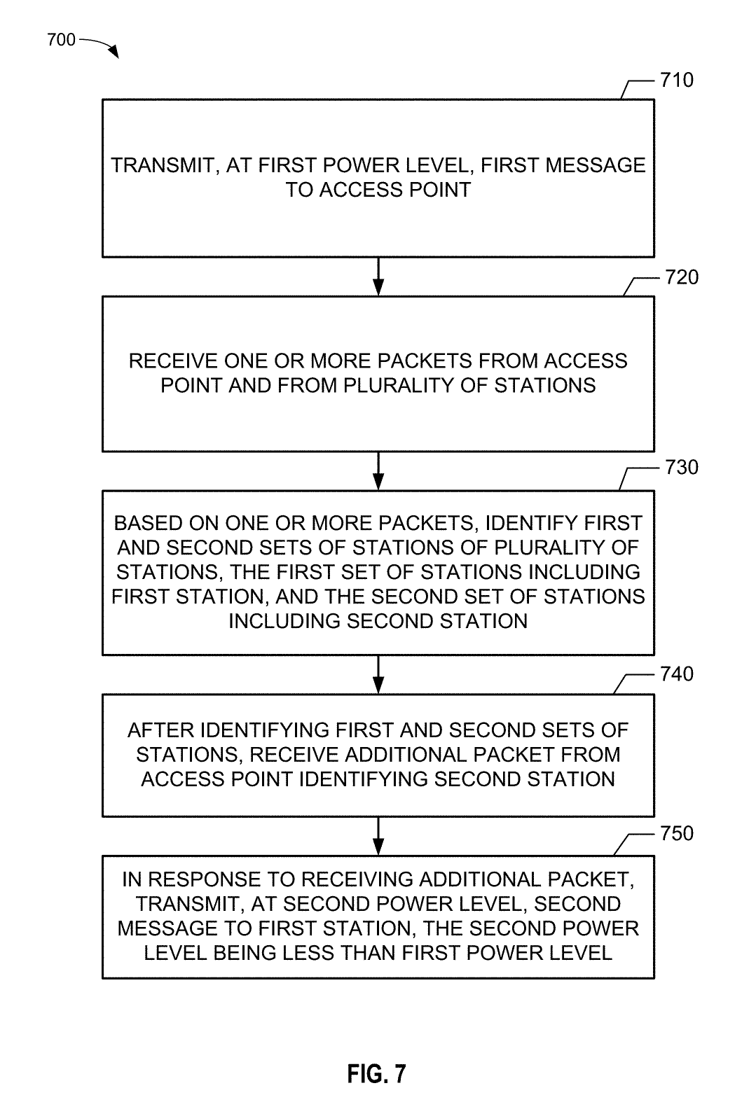

FIG. 7 is a flowchart 700 of a method for wireless communication, in accordance with an implementation. At step 710, the method includes transmitting, at a first power level, a first message to an access point. At step 720, the method includes receiving one or more packets from the access point and from a plurality of stations. At step 730, the method includes, based on the one or more packets, identifying first and second sets of stations of the plurality of stations, the first set of stations including a first station, and the second set of stations including a second station. At step 740, the method includes, after identifying the first and second sets of stations, receiving an additional packet from the access point, the additional packet identifying the second station. At step 750, the method includes, in response to receiving the additional packet, transmitting, at a second power level, a second message to the first station, the second power level being less than the first power level.

In one example, means for transmitting may comprise the transmitter 210 of the wireless device 202 described in connection with FIG. 2. In one example, means for receiving may comprise the receiver 212 of the wireless device 202 described in connection with FIG. 2. In one example, means for processing, identifying, determining, generating, matching, and/or adjusting may comprise the processor 204 of the wireless device 202 described in connection with FIG. 2. In one example, means for storing may comprise the memory 206, for example, in connection with the processor 204, of the wireless device 202 described in connection with FIG. 2.

As used herein, the term “determining” and/or “identifying” encompass a wide variety of actions. For example, “determining” and/or “identifying” may include calculating, computing, processing, deriving, choosing, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, identifying, establishing, selecting, choosing, determining and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the figures may be performed by corresponding functional means capable of performing the operations.

As used herein, the term interface may refer to hardware or software configured to connect two or more devices together. For example, an interface may be a part of a processor or a bus and may be configured to allow communication of information or data between the devices. The interface may be integrated into a chip or other device. For example, in some embodiments, an interface may comprise a receiver configured to receive information or communications from a device at another device. The interface (e.g., of a processor or a bus) may receive information or data processed by a front end or another device or may process information received. In some embodiments, an interface may comprise a transmitter configured to transmit or communicate information or data to another device. Thus, the interface may transmit information or data or may prepare information or data for outputting for transmission (e.g., via a bus).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) signal or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. Thus, in some aspects, computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by an access point 104, a station 106, and/or another device as applicable. For example, such a device can be coupled to a server to facilitate the transfer of means for performing the methods described herein. In some aspects, the means for receiving may comprise one or more of the receiver 212, the transceiver 214, the digital signal processor 220, the processor 204, the memory 206, the signal detector 218, the antenna 216, the WLAN modem 238, or equivalents thereof. In some aspects, means for transmitting may comprise one or more of the transmitter 210, the transceiver 214, the digital signal processor 220, the processor 204, the memory 206, the WLAN modem 238, the antenna 216, or equivalents thereof. In some aspects, the means for determining, means for identifying, means for generating, means for matching, means for storing, and/or means for adjusting may comprise one or more of the digital signal processor 220, the processor 204, the memory 206, the user interface 222, the WLAN modem 238, or equivalents thereof. Alternatively, various methods described herein can be provided via storage means (e.g., RAM, ROM, a physical storage medium such as a compact disc (CD) or floppy disk, etc.), such that a wireless device 202, an access point 104, a station 106, and/or another device can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of wireless communication, comprising, at a wireless device:
transmitting, at a first power level, a first message to an access point;
receiving one or more packets from the access point and from a plurality of stations;
based on the one or more packets, identifying first and second sets of stations of the plurality of stations, the first set of stations including a first station, and the second set of stations including a second station;
after identifying the first and second sets of stations, receiving an additional packet from the access point, the additional packet identifying the second station; and
in response to receiving the additional packet, transmitting, at a second power level, a second message to the first station, the second power level being less than the first power level.

2. The method of claim 1, the method further comprising, at the wireless device:
prior to transmitting the first message, transmitting, at a preliminary power level, one or more preliminary messages to the access point;
receiving one or more preliminary communications from the access point, each of the one or more preliminary communications including an error indication; and
determining the first power level based on the one or more preliminary communications and their respective error indications, the first power level being less than the preliminary power level, and the first power level comprising a minimum power level required for messages transmitted from the wireless device to reach the access point.

3. The method of claim 1, wherein the one or more packets from the one or more stations comprise ready-to-send (RTS) packets, each of the RTS packets including a transmitter identifier, and wherein the one or more packets from the access point comprise clear-to-send (CTS) packets, each of the CTS packets including a receiver identifier, the method further comprising, at the wireless device:
generating a client list including each of the transmitter and receiver identifiers, wherein each of the transmitter identifiers correspond to one of the plurality of stations, and wherein each of the receiver identifiers correspond to one of the plurality of stations; and
identifying one or more stored transmitter identifiers that match one or more stored receiver identifiers.

4. The method of claim 3, the method further comprising, at the wireless device:
identifying one of the plurality of stations as part of the first set of stations when the client list includes both the receiver identifier and the transmitter identifier for the corresponding station, each of the stations of the first set of stations having a first distance characteristic; and
identifying one of the plurality of stations as part of the second set of stations when the client list includes only the receiver identifier for the corresponding station, each of the stations of the second set of stations having a second distance characteristic, the second distance characteristic being different from the first distance characteristic, and wherein the first and second sets of stations are mutually exclusive.

5. The method of claim 1, wherein the additional packet from the access point comprises a clear-to-send (CTS) packet including a receiver identifier, the method further comprising, at the wireless device:
matching the receiver identifier to one of the stations of the second set of stations; and
based on the matching, determining that the CTS packet is addressed to one of the stations of the second set of stations.

6. The method of claim 5, the method further comprising, at the wireless device:
based on determining that the CTS packet is addressed to one of the stations of the second set of stations, determining that the wireless device can directly communicate with one or more of the stations of the first set of stations; and
adjusting a power level of the wireless device to be equal to the second power level for directly communicating with one or more of the stations of the first set of stations.

7. The method of claim 1, wherein the second power level comprises a minimum power level required for messages transmitted from the wireless device to bypass the access point and reach the first station directly, and wherein the additional packet from the access point comprises a duration field identifying a duration, the method further comprising, at the wireless device:
for the duration, transmitting, at the second power level, the second message, or the second message and one or more additional messages, directly to the first station; and
after the duration, adjusting a power level of the wireless device to be equal to the first power level.

8. An apparatus for wireless communication, the apparatus comprising:
a transmitter configured to transmit, at a first power level, a first message to an access point;
a receiver configured to receive one or more packets from the access point and from a plurality of stations; and
a processor configured to, based on the one or more packets, identify first and second sets of stations of the plurality of stations, the first set of stations including a first station, and the second set of stations including a second station;
the receiver being further configured to, after the processor identifies the first and second sets of stations, receive an additional packet from the access point, the additional packet identifying the second station; and
the transmitter being further configured to, in response to the receiver receiving the additional packet, transmit, at a second power level, a second message to the first station, the second power level being less than the first power level.

9. The apparatus of claim 8, further comprising:
prior to transmitting the first message, the transmitter being further configured to transmit, at a preliminary power level, one or more preliminary messages to the access point;
the receiver being further configured to receive one or more preliminary communications from the access point, each of the one or more preliminary communications including an error indication; and
the processor being further configured to determine the first power level based on the one or more preliminary communications and their respective error indications, the first power level being less than the preliminary power level, and the first power level comprising a minimum power level required for messages transmitted from the apparatus to reach the access point.

10. The apparatus of claim 8, wherein the one or more packets from the one or more stations comprise ready-to-send (RTS) packets, each of the RTS packets including a transmitter identifier, and wherein the one or more packets from the access point comprise clear-to-send (CTS) packets, each of the CTS packets including a receiver identifier, the processor being further configured to:
generate a client list including each of the transmitter and receiver identifiers, wherein each of the transmitter identifiers correspond to one of the plurality of stations, and wherein each of the receiver identifiers correspond to one of the plurality of stations; and
identify one or more stored transmitter identifiers that match one or more stored receiver identifiers.

11. The apparatus of claim 8, wherein the processor is further configured to:
identify one of the plurality of stations as part of the first set of stations when the client list includes both the receiver identifier and the transmitter identifier for the corresponding station, each of the stations of the first set of stations having a first distance characteristic; and
identify one of the plurality of stations as part of the second set of stations when the client list includes only the receiver identifier for the corresponding station, each of the stations of the second set of stations having a second distance characteristic, the second distance characteristic being different from the first distance characteristic, and wherein the first and second sets of stations are mutually exclusive.

12. The apparatus of claim 8, wherein the additional packet from the access point comprises a clear-to-send (CTS) packet including a receiver identifier, the processor being further configured to:
match the receiver identifier to one of the stations of the second set of stations; and
based on the matching, determine that the CTS packet is addressed to one of the stations of the second set of stations.

13. The apparatus of claim 12, the processor being further configured to:
based on determining that the CTS packet is addressed to one of the stations of the second set of stations, determine that the apparatus can directly communicate with one or more of the stations of the first set of stations; and
adjust a power level of the apparatus to be equal to the second power level for directly communicating with one or more of the stations of the first set of stations.

14. The apparatus of claim 8, wherein the second power level comprises a minimum power level required for messages transmitted from the apparatus to bypass the access point and reach the first station directly, and wherein the additional packet from the access point comprises a duration field identifying a duration, wherein:
the transmitter is further configured to, for the duration, transmit, at the second power level, the second message, or the second message and one or more additional messages, directly to the first station; and
the processor is further configured to, after the duration, adjust a power level of the apparatus to be equal to the first power level.

15. An apparatus for wireless communication, comprising:
means for transmitting, at a first power level, a first message to an access point;
means for receiving one or more packets from the access point and from a plurality of stations;
means for, based on the one or more packets, identifying first and second sets of stations of the plurality of stations, the first set of stations including a first station, and the second set of stations including a second station;
means for storing the first and second sets of stations of the plurality of stations;
means for, after identifying the first and second sets of stations, receiving an additional packet from the access point, the additional packet identifying the second station; and
means for, in response to receiving the additional packet, transmitting, at a second power level, a second message to the first station, the second power level being less than the first power level.

16. The apparatus of claim 15, the apparatus further comprising:
means for, prior to transmitting the first message, transmitting, at a preliminary power level, one or more preliminary messages to the access point;
means for receiving one or more preliminary communications from the access point, each of the one or more preliminary communications including an error indication; and
means for determining the first power level based on the one or more preliminary communications and their respective error indications, the first power level being less than the preliminary power level, and the first power level comprising a minimum power level required for messages transmitted from the apparatus to reach the access point.

17. The apparatus of claim 15, wherein the one or more packets from the one or more stations comprise ready-to-send (RTS) packets, each of the RTS packets including a transmitter identifier, and wherein the one or more packets from the access point comprise clear-to-send (CTS) packets, each of the CTS packets including a receiver identifier, the apparatus further comprising:
means for generating a client list including each of the transmitter and receiver identifiers, wherein each of the transmitter identifiers correspond to one of the plurality of stations, and wherein each of the receiver identifiers correspond to one of the plurality of stations;
means for identifying one or more stored transmitter identifiers that match one or more stored receiver identifiers;
means for identifying one of the plurality of stations as part of the first set of stations when the client list includes both the receiver identifier and the transmitter identifier for the corresponding station, each of the stations of the first set of stations having a first distance characteristic; and
means for identifying one of the plurality of stations as part of the second set of stations when the client list includes only the receiver identifier for the corresponding station, each of the stations of the second set of stations having a second distance characteristic, the second distance characteristic being different from the first distance characteristic, and wherein the first and second sets of stations are mutually exclusive.

18. The apparatus of claim 15, wherein the additional packet from the access point comprises a clear-to-send (CTS) packet including a receiver identifier, the apparatus further comprising:
means for matching the receiver identifier to one of the stations of the second set of stations; and
means for, based on the matching, determining that the CTS packet is addressed to one of the stations of the second set of stations.

19. The apparatus of claim 18, the apparatus further comprising:
means for, based on determining that the CTS packet is addressed to one of the stations of the second set of stations, determining that the apparatus can directly communicate with one or more of the stations of the first set of stations; and
means for adjusting a power level of the apparatus to be equal to the second power level for directly communicating with one or more of the stations of the first set of stations.

20. The apparatus of claim 15, wherein the second power level comprises a minimum power level required for messages transmitted from the apparatus to bypass the access point and reach the first station directly, and wherein the additional packet from the access point comprises a duration field identifying a duration, the apparatus further comprising:
means for, for the duration, transmitting, at the second power level, the second message, or the second message and one or more additional messages, directly to the first station; and
means for, after the duration, adjusting a power level of the apparatus to be equal to the first power level.
